(19) United States
(12) Patent Application Publication
(10) Pub. No.: US 2004/0008895 A1
(43) Pub. Date: Jan. 15, 2004

(54) Method and system for encoding, decoding and/or for transmitting locating information

(76) Inventors: Matthias Hessling, Hildesheim (DE); Cornelius Hahlweg, Hamburg (DE)

Correspondence Address: KENYON & KENYON, ONE BROADWAY, NEW YORK, NY, 10004, US

(21) Appl. No.: 10/332,450

(22) PCT Filed: Jul. 5, 2001
(86) PCT No.: PCT/DE01/02496

(30) Foreign Application Priority Data
Jul. 7, 2002 (DE) 100-33-193.9

(51) Int. Cl. G06K 9/36

(52) U.S. Cl. 382/242

(57) ABSTRACT

A method and device for coding, decoding and/or transmitting location data is proposed, a path and a main path encompassing points; the at least one path being provided as a subpath with respect to the main path; at least one path point, as a branching point, being identical to a main point and the location data being arranged according to the data format in the sequence of the main points.

### BACKGROUND INFORMATION

The present invention relates to a method for coding, decoding and or transmitting location data according to the preamble of the main claim. Digital maps are already known whose contents are coded according to proprietary or standard formats. Also known are methods in which subnetworks in the form of corridors about a main route are used, for example, for vehicle navigation. Ideas for transmitting entire maps also exist, particularly via an air interface.

### SUMMARY OF THE INVENTION

As compared to that, the method according to the present invention and the device having the features of the other independent claims have the advantage that a meaningful description is possible of networks or subnetworks of digital maps that are needed for navigational purposes and reporting purposes. By use of the proposed data structure, in the same manner both geometric descriptions and attributes of geometric objects may be transmitted for objects of any complexity, i.e. up to subnetworks, efficiently and in a manner that is clearly interpretable. According to the present invention it is possible to define each individual point of the geometric description, that is, to state a reference to a description or the like. It is also possible to do this for entire point sets and corresponding traverses. Branching can also be transmitted. It is particularly advantageous that the location data follow one another in the sequence of their physical arrangement, in the data format according to the present invention, on a single recurrence plane.

It is also of advantage that the location data encompass a plurality of paths and that a second path is a subpath with respect to a first path, at least one path point of the second path as a branching point being identical to a path point of the first path. Thereby it is possible to partition a plurality of points, or rather a network, from points connected to one another, i.e. to decompose them completely into paths, which yields a superordination or subordination of certain paths as compared to other paths, and the method for partitioning being continued recursively for the subpaths thus partitioned.

It is further advantageous that the at least one path point of the second path, which is a subpath with respect to the first path, is the initial point of the second path. This ensures that an subpath always begins at a point of intersection or a nodal point, and that there is thus no doubt in regard to the digitalization direction on a path.

Furthermore, it is advantageous that, in the case of the coding of location data, for a predefined plurality of points the definition of the main path and of the at least one path (=partitioning) is predefined as a function of a partitioning parameter. This makes possible a partitioning according to rational criteria.

It is also advantageous that the partitioning parameter is the roadway resistance associated with a point-to-point connection between two points of the plurality of points. From this there comes about the advantage that a partitioning is undertaken which is distinguished by the fact that the main path represents the fastest route. In this context, in general, superordinated roads or paths of the digital map correspond to those roads that have a low point-to-point resistance.

It is also advantageous that the partitioning parameter is associated with the road designation and/or the road category of a point-to-point connection between two points of the plurality of points. From this there comes about a correspondence of the designations of the digital map and the designation of roads in reality.

It is also advantageous that open paths are provided. Because of that, any targets which, for example, have only one access path, may be integrated in a navigable manner into the digital map.

It is also advantageous that the paths form closed loops. Because of that, the location data organized according to the data format according to the present invention are able to be used also for such situations as those in which closed loops are a necessary supposition, such as in certain proprietary navigational systems.

It is also advantageous that, in addition to the plurality of points new points and/or new point-to-point connections are integrated into the location data, whereby the description of the plurality of points is maintained. Thereby additional paths, points and cross-references, i.e references to points or paths already described, may be inserted into an existing network or an existing quantity of location data without change in the parts of the previously numbered network, thereby thus creating an expandable map.

Furthermore, it is of advantage that the data format provides for the representation of location data according to a description language (markup language), particularly XML-based (extended markup language). Thereby, objects of any complexity are able to be interpreted efficiently and unequivocally.

Then again, it is of advantage that the data format provides associating an attribute to a point of the plurality of points or to several points of the plurality of points. Thereby an attribution can be made path-oriented, edge-oriented and point-oriented. Thereby it is possible to assign any attribute, i.e. descriptive data, to the elements of location data.

### BRIEF DESCRIPTION OF THE DRAWINGS

An exemplary embodiment of the present invention is depicted in the drawings and will be explained in greater detail in the following description. The figures show:

FIG. 1 a system for transmitting location data,

FIG. 2 a first diagram of a digital map,

FIG. 3 a second diagram of the digital map and

FIG. 4 a diagram of a supplemented digital map.

### DESCRIPTION OF THE EXEMPLARY EMBODIMENT

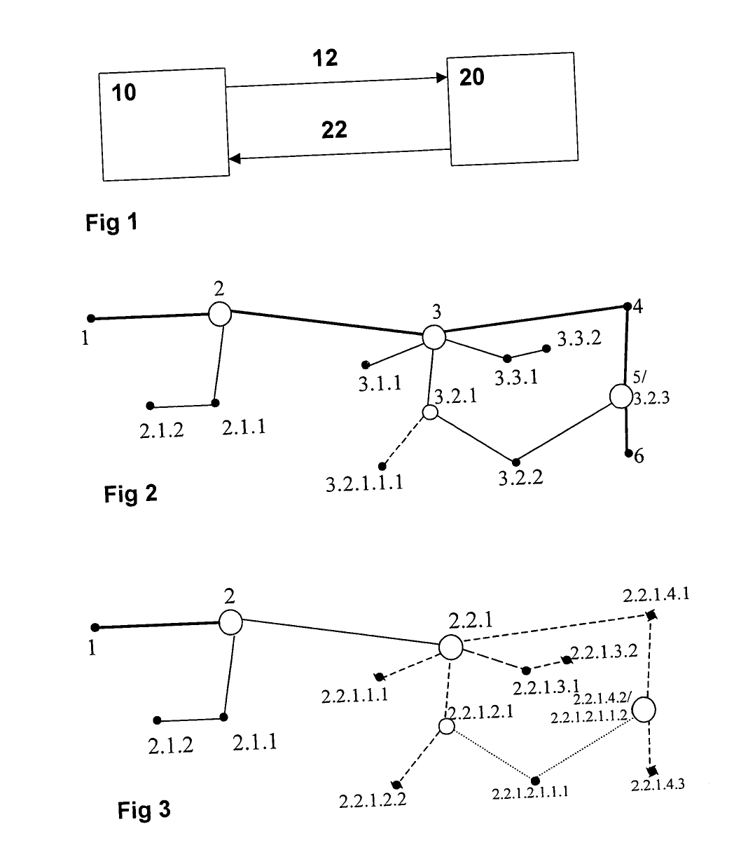

FIG. 1 shows a system for transmitting location data according to a data format according to the present invention. In this context, a first system unit 10 is connected to a second system unit 20 via two transmission channels. Via first transmission channel 12 data from first system unit 10 may be transmitted to second transmission unit 20, and via a second transmission channel 22 data from second system unit 20 may be transmitted to first transmission unit 10. Transmission channels 12, 22, in this connection, are designed as air interfaces, local networks (LAN=local area network), other wire-bound connections, infrared connections, mobile communications connections and the like. When first system unit 10 is designed, for example, as an inquiry device, it makes an inquiry to second system unit 20, designed, for example, as a service provider, via first transmission channel 12, whereupon second system unit 20 sends back the result of the inquiry via second transmission channel 22 to first system unit 10. First system unit 10 is in this case a motor vehicle, for example, which is asking a service provider (second system unit 20) for location data. The location data, transmitted via transmission channels 12, 22 according to the present invention, are coded according to a data format. Therefore, when the request and the reply by first and second system units 10, 20 are formulated, the location data to be sent are first coded in accordance with the data format according to the present invention. The location data are subsequently transmitted, and at the receiver the location data are decoded. For this, and depending on the particular use, system units 10, 20 each has either only a coding device or a decoding device or both a decoding and a coding device. Thus the system shown in FIG. 1 is a set-up for coding, for decoding and/or for the transmission of location data.

FIG. 2 shows, asc an example, a first diagram of a digital map. In FIG. 2, a first point 1 is connected to a second point 2, which is connected to a third point 3, which is connected to a fourth point 4, which is connected to a fifth point 5/3.2.3, which is connected to a sixth point 6. Second point 2 is connected to a seventh point 2.1.1 which is connected to an eighth point 2.1.2. Third point 3 is connected to a ninth point 3.1.1. The third point is also connected to a tenth point 3.2.1, which is connected to an eleventh point 3.2.2, which is connected to fifth point 5/3.2.3. Furthermore, point 3 is connected to a twelfth point 3.3.1, which is connected to a thirteenth point 3.3.2. Tenth point 3.2.1 is also connected to a fourteenth point 3.2.1.1.1. The connections between two points of location data correspond to roads on the digital map. Now, there are several possibilities of coding such a plurality of points and their connections which represent the fundamental structure of a digital map. According to the present invention, a portion of the points and their connections to paths or a main path are combined for the coding of the plurality of points and their connections. It is provided by the present invention that a road or a path connection between two points is expressed in that the two points in a path or in the main path are arranged one after the other in the data format of the location data. Correspondingly, in the first illustration of the digital map, a sub-quantity of the plurality of points is summarized to a main path, which encompasses the first to sixth point 1, 2, 3, 4, 5/3.2.3, 6. The main path in the first illustration of the digital map encompasses points which are not junctions (first, fourth and sizth points 1, 4, 6) and points that are junctions (second, third and fifth points 2, 3 and 5/3.2.3). At junctions or nodes, the main path is linked to another path. For example, the second, the seventh and the eighth points 2, 2.1.1, 2.1.2 form a first path branching off from the main path at second point 2. That is why the first path is also denoted as subpath with respect to the main path. In an analogous manner, a second path, a third path and a fourth path branch off from third point 3. The second path includes only third point 3 and ninth point 3.1.1. The third path includes third, tenth, eleventh and fifth points 3, 3.2.1, 3.2.2, 5/3.2.3. The fourth path includes third point 3, twelfth point 3.3.1 and thirteenth point 3.3.2. The second, third and fourth paths are each subpaths with respect to the main path. At tenth point 3.2.1 a fifth path branches off from the third path. The fifth path includes tenth point 3.2.1 and fourteenth point 3.2.1.1.1. The fifth path is a subpath with respect to the third path. The concept “subpath” is thus relative. It is a matter of which pair of paths is being considered. The third path forms a closed loop with the main path because the endpoint of the third path (fifth point 5/3.2.3) is identical to fifth point 5, i.e. The fifth point of the main path.

In FIG. 3 a second diagram of the digital map is shown, having the same points as in the first diagram. The points, in turn, are connected in the same way as in the first diagram. The difference between FIG. 2 and FIG. 3 is the different partitioning of the points or rather, of the digital map, i.e. the combination of different sub-quantities of the points to a main path or to further paths is distinguishable in the different representations. Therefore, the marking of the points in the second diagram are different because of the different partitioning. Yet, in both illustrations, in each case of the first, second, third, . . . , and fourteenth points, the same points are involved (and their connections were also assumed to be identical); the only thing that was changed was the numbering and the hierarchical planes. In FIG. 3, the main path of the digital map consists, for example, only of first point 1 and second point 2. In the second diagram of the map, the main path has two subpaths. They are a sixth path, which in the second diagram includes the second, seventh and eighth points (2, 2.1.1, 2.1.2) and a seventh path which, in the second diagram, is encompassed by the second and third points (2, 2.2.1). The sixth and seventh paths in the second diagram are subpaths compared to the main path. An eighth path starts from third point 2.2.1 which includes third point 2.2.1 and ninth point 2.2.1.1.1. A ninth path also starts from third point 2.2.1, and it includes third point 2.2.1, tenth point 2.2.1.2.1 and fourteenth point 2.2.1.2.2. A tenth path also starts from third point 2.2.1, and it includes third point 2.2.1, twelfth point 2.2.1.3.1 and thirteenth point 2.2.1.3.2. A eleventh path also starts from third point 2.2.1, and it includes third point 2,2,1, fourth point 2.2.1.4.1, fifth point 2.2.1.4.2/2.2.1.2.1.1.2 and sixth point 2.2.1.4.3. From tenth point 2.2.1.2.1 a twelfth path branches off which includes tenth point 2.2.1.2.1, eleventh point 2.2.1.2.1.1.1 and fifth point 2.2.1.4.2/2.2.1.2.1.1.2.

Because of the different subdivision of the plurality of points into a main path and several additional paths, there results in FIG. 3 a greater depth of nesting for describing the digital map than in the first diagram of the digital map. For example, in the second diagram there are four paths (namely, the eighth, ninth, tenth and eleventh path) which are each subpaths with respect to one subpath of the main path; in the first diagram there is only one path (the fifth path) on this recurrence plane or hierarchical plane. A greater depth of nesting requires a greater coding effort, which in a needless manner requires computing capacity during coding and decoding, as well transmission bandwidth during the transmission of the location data. Therefore, a representation of digital maps having as little depth of nesting as possible is desirable. According to the present invention, this is realized in that the partitioning of the digital map is picked in such a way that the number of hierarchical planes (=the depth of nesting or depth of recurrence) is held low, and thus effective coding is achieved. Therefore, the partitioning is advantageously oriented towards the application purpose of the data material, or towards its properties, although the subdivision of the network to be described, or rather the digital map may be done arbitrarily, as shown in the first and second diagram of the digital map.

If, for example; we are talking about the coding of a navigable corridor about a main route which is transmitted by a service provider to an infrastructure-supported vehicle navigation system, and the criterion for setting up the navigation corridor was, for example, a low point-to-point resistance on the navigation route, then it is meaningful also to apply the point-to-point resistance as partitioning parameter for partitioning the points forming the navigation corridor, particularly for the definition of the main path. Thereby, for example, the main path corresponds essentially to the route to be navigated, and thus attains a great length, whereby additional and, in this case, unnecessary hierarchical planes or recurrence planes, because of a different partitioning along the main path, are avoided.

If, for example, known routing algorithms such as “Fort Moore” are used for generating the navigation corridor, the result is a subnet in the form of a logical tree structure. The resulting subpaths may be ordered according to a criterion, such as the point-to-point resistance and thereby prioritized. If the same prioritization is accepted for the partitioning, one obtains a description which is interpretable along the most favorable route, which in the navigation process corresponds to the remaining of the vehicle on the main route. Only upon the vehicle's leaving the main route do the secondary paths come in useful. Secondary paths are such paths as are subpaths with respect to the main path. According to the present invention, the location data are described sequentially along the main path, so that in the example, those parts of the navigation corridor which are instantaneously not required for position finding (since they lie at points of the main path that lie far from the point under consideration) may be disregarded. This saves computing capacity and transmission bandwidth.

According to the present invention it is provided to use the road designation and/or the road category of a point-to-point connection between two points as the partitioning parameter. If the navigation corridor, for example, runs for a long distance along an express highway, it may be meaningful to select the express highway as the main route. For this purpose, then, the road designation of the express highway is used as the partitioning parameter. Then, for example, the roads below the express highway category may be taken as further values in the spectrum of such a partitioning parameter.

As further possibilities for a partitioning parameter there is also provided the construction stage, the touristic attractiveness, or the like.

According to the present invention it is possible to define each individual point of the geometric description, that is, to state a reference to a description or the like. It is also possible to state such a description for entire point sequences, i.e. traverses or paths and to represent branching, in order also to be able to code, decode and transmit networks, i.e. complete digital (partial) maps. It is advantageous that, in reverse, a point or a point sequence may be assigned without problem to each descriptive attribute. This may be done, for example, using a cross reference table. In this case, for example, the data format provides, in addition to the location data and the description attributes, to include assignment information which permit assignment between the location data and the description attributes or even the description data. Thereby the description data may be coded, decoded and transmitted separately from the location data. In this case, the assignment data are organized in the form of assignment entries and include in each case a reference both to a point and also to a description information such as in the form of a description attribute which is to be associated with a point or a point connection. In this context, according to the present invention, it is particularly both permissible that an assignment entry produces a connection between exactly one point and exactly one description attribute, and that an association between a number of a plurality of points and exactly one description attribute is permissible, or between exactly one point and a number of a plurality of description attributes. Because of this, the coding efficiency is increased. In an advantageous manner, according to the present invention, the assignment entries are arranged in the form of a table.

Networks in particular come into consideration as location data according to the present invention, for which a main path may be determined, secondary traces, i.e. paths which represent subpaths with respect to the main path or another path, not having, of necessity, to form closed loops. This case appears in particular in telematic applications, such as POI (point of interest) referencing, subnetwork transmission and route (corridor) transmission and travel guides.

The partitioning, according to the present invention, of map networks furnished with description attributes, in particular road networks according to geometrical points of view, permits, according to the present invention, that a consistent main path be determined in the network to be described; that the coding takes place in a defined direction along the main path, that the remaining paths may be regarded as subpaths with respect to the main path (secondary branches), that each path (be it a main path or subpath with respect to the main path or another path) may include branching point from which, in turn, paths proceed which are subpaths with respect to the path contained in the branching point. Furthermore, in the data format according to the present invention, a unique number is assigned to each point, a point representing a node, which consequently is a branching point, generating, in the description of the digital map, both a first entry which points out that the node is a part of the path about to be described, and a second entry which points out that the node is also a part of a subpath with respect to the path described. In this context, the second entry is implicitly brought about in that the first point of the subpath after the node is in the first place of a nested definition after the beginning of the definition of the node. Since any paths of digital maps coded according to the present invention have a defined digitization direction, the digitization direction is used to increase the coding efficiency by having branching paths described only starting from the node which represents the starting point of the subpath. In the case of subpaths which are connected by their endpoint or by any other of their points to other paths, only a reference information is provided for the definitions of the connected paths. This is the case, for instance, with closed loops. For the description of any desired path, i.e. both the main path and another path, the points contained in this path are described corresponding to their geometric arrangement, i.e. in the interpretation direction or in digitization direction following one another, especially according to a markup language, the beginning of each new point being characterized by a descriptive symbol (tag).

In this context, besides the geographical coordinates, any desired attributes may be assigned to each point. This is also possible for point sequences, whereby path-oriented, edge-oriented and point-oriented attributions may take place. In this connection, the attributes may represent in particular, names, such as road names, segment characteristics such as speed limits, risk of a traffic jam or the like, or navigation-relevant attributes Furthermore, the choice of partitioning is arbitrary. A substantial advantage is the fact that, for example, in the transmission of so-called route corridors, a prioritization of paths may be undertaken, as well as directly linked parts may be directly read out. A further advantage is the limitation of the recurrence depth achieved by the partitioning according to the present invention, which is an essential condition for effective coding. The proposed method is especially suitable also for geometrically oriented referencing methods.

With regard to the representation of coordinates, various expressions are conceivable. This relates, besides to the unit (in dgrees, minutes, seconds or decimal, integer or double precision) and the reference system (WGS84 or similar ones) also to the question concerning absolute or relative representation of the coordinates, in the case of relative representation, particularly with reference to a predefined absolute coordinate.

Below is given an example for the description of the first diagram, shown in FIG. 2, of the digital map represented by the first to fourteenth points. As an example, a formulation corresponding to description language XML (extended markup language) is selected.

| XML | | Comments |
|---|---|---|
| <NET> | | Open net |
| <ROAD> | | Open main path |
| | <P X=“” Y=“” ></NAME> </NAME> </P> | Point 1 |
| | <P X=“” Y=“” CREF=“P2”> | Open node 2 |
| | <NAME>2</NAME> | |
| | <ROAD> | Open first path |

<P X=“” Y=“” > <NAME>2.1.1</NAME> </P>
<P X=“” Y=“” > <NAME>2.1.2</NAME> </P>

| | |
|---|---|
| </ROAD> | Close subpath |
| </P> | Close node 2 |

| | |
|---|---|
| <P X=“” Y=“” CREF=“P3”> | Open node 3 |
| <NAME>3</NAME> | |

| | |
|---|---|
| <ROAD> | Open second path |

<P X=“” Y=“” > <NAME>3.1.1</NAME>
</P>

| | |
|---|---|
| </ROAD> | |
| <ROAD> | Open third path |

<P X=“” Y=“” CREF=“P3.2.1”>

<NAME>3.2.1</NAME>

| | |
|---|---|
| <ROAD> | Open fifth path |

<NAME>3.2.1.1.1</NAME> </P>

| <ROAD> | |
|---|---|
| </P> | |
| <P X=“” Y=“” > <NAME>3.2.2</NAME> </P> | |
| <CROSSREF NAME=“P5”/> | Cross reference |
| | to node 5 |

| | |
|---|---|
| </ROAD> | |
| <ROAD> | Open fourth path |

<P X=“” Y=“” > <NAME>3.3.1</NAME>
</P>
<P X=“” Y=“” > <NAME>3.3.2</NAME> </P>

| | |
|---|---|
| </ROAD> | |
| </P> | Close node 3 |
| <P X=“” Y=“” > <NAME>4</NAME> </P> | Point 4 |
| <P X=“” Y=“”CREF=“P5”> | Node 5 |
| <NAME>5</NAME> </P> | |
| <P X=“” Y=“” > <NAME>6</NAME> </P> | Point 6 |

| | |
|---|---|
| </ROAD> | Close main path |
| <NET> | Close net |

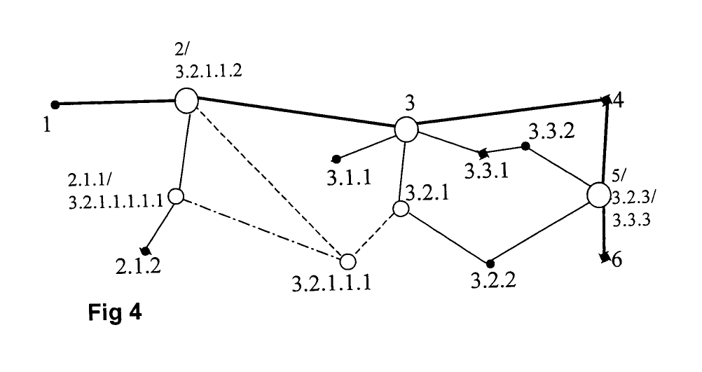

FIG. 4 is a diagram of a supplemented digital map. In this case, in the partitioned digital map as shown in the first diagram, both second point 2 and seventh point 2.1.1 are each additionally connected to fourteenth point 3.2.1.1.1. The connection between fourteenth point 3.2.1.1.1 and second point 2 represents an extension of the fifth path from tenth point 3.2.1 via fourteenth point 3.2.1.1.1 to the second point. Therefore, second point 2 may be thought of also as point 3.2.1.1.2, which is why the second point bears the designation 2/3.2.1.1.2. In contrast to the first diagram of the digital map, fourteenth point 3.2.1.1.1 in the supplemented digital map is developed as a node from which a thirteenth path branches off to seventh point 2.1.1. Therefore the seventh point may also be designated as point 3.2.1.1.1.1.1, and therefore it also bears this designation in FIG. 4. Furthermore, in the supplemented digital map thirteenth point 3.3.2 is connected to fifth point 5/3.2.3. Thus the fifth point is both a part of the main path (point 5 of the main path) and also of the third path (point 3.2.3 of the third path) and also of the fourth path (point 3.3.3 of the fourth path). Therefore, the fifth point bears all these three designations. By the simple insertion of reference data (in the example, at the fourteenth point) or of cross references (in the example, at the second, fifth, seventh and thirteenth point) onto a point that is already described, it is thus possible to provide further connections which may represent roads, for example.

What is claimed is:

1. A method for coding, decoding and/or transmitting location data in accordance with a data format,
the location data encompassing a plurality of points, wherein
at least one path and one main path are coded, decoded and/or transmitted;
the main path and the at least one path together encompassing the plurality of points;
the main path encompassing a plurality of main points of the plurality of points;
the at least one path encompassing a plurality of path points;
the at least one path being provided as a subpath with respect to the main path;
at least one path point, as a branching point, being identical to a main point; and
the location data being arranged according to the data format in the sequence of the main points.

2. The method as recited in claim 1, wherein the location data encompass a plurality of paths;
a second path is a subpath with respect to a first path, at least one path point of the second path as a branching point being identical to a path point of the first path.

3. The method as recited in one of the preceding claims, wherein the at least one path point of the second path, which is a subpath with respect to the first path, is the initial point of the second path.

4. The method as recited in one of the preceding claims, wherein in the coding of location data, for a predefined plurality of points the definition of the main path and of the at least one path (=partitioning) is undertaken as a function of a partitioning parameter.

5. The method as recited in claim 4, wherein the partitioning parameter is the point-to-point resistance associated with a point-to-point connection between two points of the plurality of points.

6. The method as recited in claim 4, wherein the partitioning parameter is associated with the road designation and/or the road category of a point-to-point connection between two points of the plurality of points.

7. The method as recited in one of the preceding claims, wherein open paths are provided.

8. The method as recited in one of the preceding claims, wherein the paths form closed loops.

9. The method as recited in one of the preceding claims, wherein in addition to the plurality of points new points and/or new point-to-point connections are integrated into the location data, the description of the plurality of points being maintained.

10. The method as recited in one of the preceding claims, wherein the data format provides associating an attribute to a point of the plurality of points or to several points of the plurality of points.

11. The method as recited in one of the preceding claims, wherein the data format provides the representation of location data according to a description language (markup language), especially XML-based (extended markup language).

12. A device for coding, decoding and/or transmitting location data in accordance with a method as recited in one of the preceding claims.
